(19) United States
(12) Patent Application Publication
(10) Pub. No.: US 2021/0326705 A1
(43) Pub. Date: Oct. 21, 2021

(54) LEARNING DEVICE, LEARNING METHOD, AND LEARNING PROGRAM

(71) Applicant: NIPPON TELEGRAPH AND TELEPHONE CORPORATION, Tokyo (JP)

(72) Inventor: Sekitoshi KANAI, Musashino-shi, Tokyo (JP)

(73) Assignee: NIPPON TELEGRAPH AND TELEPHONE CORPORATION, Tokyo (JP)

(21) Appl. No.: 17/270,056

(22) PCT Filed: Aug. 13, 2019
(86) PCT No.: PCT/JP2019/031874

§ 371 Date: Feb. 22, 2021

(30) Foreign Application Priority Data
Aug. 23, 2018 (JP) 2018-156733

(51) Int. Cl. G06N 3/08; G06N 3/04; G06K 9/62

(52) U.S. Cl. CPC G06N 3/08; G06K 9/6215; G06K 9/6242; G06N 3/0481

(57) ABSTRACT

A learning apparatus (10) includes: a generation unit (11) configured having a mathematical model for generating data through an input of a random number used for deep learning to a nonlinear function; and a prior learning unit (13) configured to cause the generation unit (11) to execute prior learning of a variance and an average using unscented transform (UT). The prior learning unit (13) estimates, using UT, the variance and the average of data generated by the generation unit (11) and updates a parameter of the generation unit (11) to minimize an evaluation function for evaluating a similarity between the estimated variance and average and a variance and an average of true data calculated in advance.

### TECHNICAL FIELD

The present invention relates to a learning apparatus, a learning method, and a learning program.

### BACKGROUND ART

Deep learning, also known as deep neural networks, has been greatly successful in image recognition, speech recognition, and the like (see Non Patent Literature 1). For tasks such as model generation of newly generating data such as images, in particular, a generative adversarial network (GAN) is used. A GAN is a model including a generator configured to generate an image or the like through nonlinear transformation or the like using a random number and an identifier configured to identify whether data is generated data or true data. In order to generate complex image data with high precision, a large amount of data and long-time learning are needed. Thus, curriculum learning (see Non Patent Literature 2) and pretraining that enhance efficiency of learning through prelearning of easy tasks have been proposed in deep learning.

In regard to pretraining of a GAN, for example. A method using likelihoods for series data and the like have been proposed (see Non Patent Literature 3). Also, unscented transform (UT) has been used for estimating states of nonlinear dynamic systems (see Non Patent Literature 4). UT is a technique of estimating an average and variance of an output when a probability variable with a known covariance matrix and a known average is input to a nonlinear function.

### CITATION LIST

### Non Patent Literature

Non Patent Literature 1: Ian Goodfellow, Yoshua Bengio, and Aaron Courville, Deep learning, MIT press, 2016
Non Patent Literature 2: Yoshua Bengio, et al. “Curriculum Learning” Proceedings of the 26th annual international conference on machine learning, ACM, 2009
Non Patent Literature 3: Lantao Yu, et al. “SeqGAN: Sequence Generative Adversarial Nets with Policy Gradient” AAAI, 2017
Non Patent Literature 4: Toni Katayama, Nonlinear Kalman Filter, Asakura Publishing Co., Ltd., 2011

### SUMMARY OF THE INVENTION

### Technical Problem

However, according to the method described in Non Patent Literature 3, complicated processing of setting a likelihood function on the assumption of a probabilistic model is needed, and there are cases in which it is possible to efficiently perform deep learning. Thus, a large amount of data and learning for a long period of time are still needed to generate complicated image data with high precision.

The present invention was made in view of the aforementioned circumstances, and an object thereof is to provide a learning apparatus, a learning method, and a learning program that enable deep learning to be efficiently performed.

### Means for Solving the Problem

In order to solve the aforementioned problem and achieve the object, a learning apparatus according to the present invention includes: a generation unit having a mathematical model for generating data through an input of a random number used for deep learning to a nonlinear function; and a prior learning unit configured to cause the generation unit to execute prior learning of a variance and an average using unscented transform.

### Effects of the Invention

According to the present invention, deep learning can be efficiently performed.

### BRIEF DESCRIPTION OF DRAWINGS

FIG. 1 is a schematic view illustrating an overview configuration of a learning apparatus according to an embodiment.

FIG. 2 is a diagram for explaining a deep learning model.

FIG. 3 is a diagram for explaining GAN learning.

FIG. 4 is a diagram for explaining an application of UT to a generation unit illustrated in FIG. 1.

FIG. 5 is a flowchart illustrating a processing procedure for prior learning processing according to the embodiment.

FIG. 6 is a diagram illustrating an example of a computer that realizes the learning apparatus by executing a program.

### DESCRIPTION OF EMBODIMENTS

Hereinafter, embodiments of the present invention will be described in detail with reference to the drawings. The present invention is not limited to the embodiments. In the description of the drawings, the same parts are denoted by the same reference signs. In a case in which A that is a vector, a matrix, or a scalar is described as “\hat{ }A” below, this is assumed to be equivalent to “the symbol ‘\hat{ }’ above ‘A’”.

### EMBODIMENT

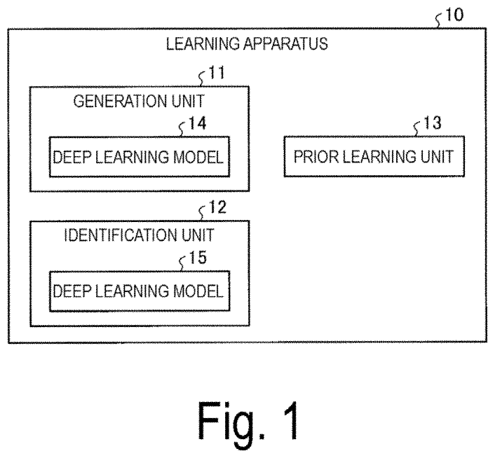

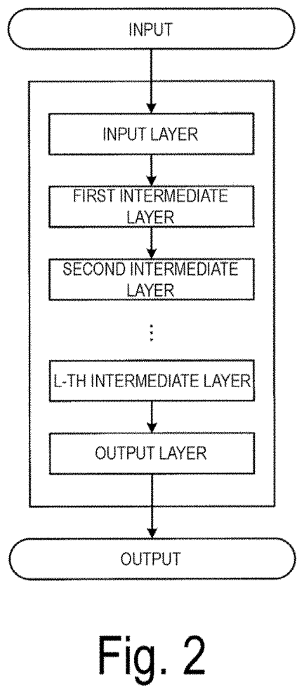

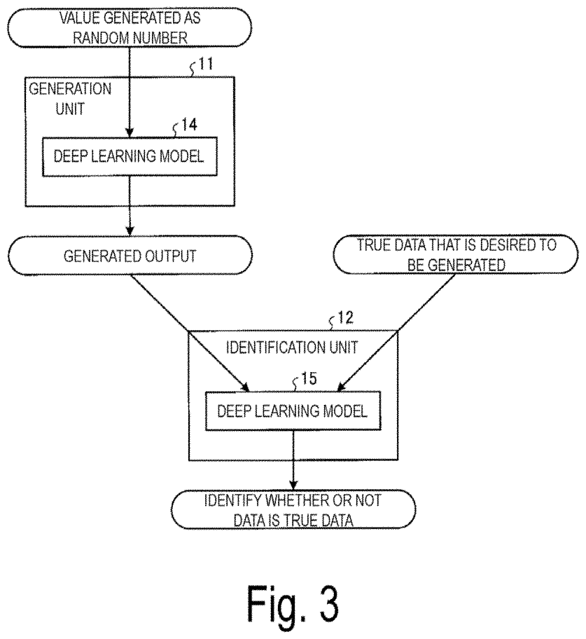

First, an overview configuration and a flow and a specific example of evaluation processing of a learning apparatus according to an embodiment will be described below. FIG. 1 is a schematic diagram illustrating an overview configuration of the learning apparatus according to the embodiment. FIG. 2 is a diagram for explaining a deep learning model. FIG. 3 is a diagram for explaining GAN learning.

A learning apparatus 10 according to the embodiment is realized by a computer including a read only memory (ROM), a random access memory (RAM), a central processing unit (CPU), and the like reading a predetermined program and by the CPU executing the predetermined program. The learning apparatus 10 has a network interface card (NIC) or the like and can also communicate with other apparatuses via an electric communication line such as a local area network (LAN) or the Internet. The learning apparatus 10 performs learning using a GAN. As illustrated in FIG. 1, the learning apparatus 10 has a generation unit 11, an identification unit 12, and a prior learning unit 13. The generation unit 11 and the identification unit 12 have deep learning models 14 and 15.

The generation unit 11 has a mathematical model (deep learning model 14 (see FIG. 2)) for generating data through an input of a random number used for deep learning to a nonlinear function. The generation unit 11 uses the deep learning model 14 to generate pseudo data using a random number as an input, as illustrated in FIG. 3. The random number to be input to the generation unit 11 is a randomly generated value and is a random number used for image generation based on deep learning. The generation unit 11 generates data through an input of the random number to a nonlinear function.

As illustrated in FIG. 2, the model for the deep learning has an input layer which signals enter, one or a plurality of intermediate layers configured to transform signals from the input layer in various manners, and an output layer configured to transform signals from the intermediate layers into outputs such as probabilities.

Input data is input to the input layer. In the case of a generator for image generation using a GAN, for example, a pixel value of a generated pseudo image is output from the output layer. On the other hand, a score indicating which of true data and pseudo data an input corresponds to, for example, is output in a range from 0 to 1 as an output of the identifier of the GAN.

The identification unit 12 uses the deep learning model 15 (see FIG. 3) using data that is desired to be learned and data generated by the generation unit 11 as inputs to identify whether or not the generated data is true data. Then, the identification unit 12 adjusts a parameter of the deep learning model 14 of the identification unit 12 such that the generated data further approaches true data.

The prior learning unit 13 causes the generation unit 11 to executes prior learning of a variance and an average using UT. The prior learning unit 13 causes the generation unit 11 to perform prior learning using a variance and an average after non-linear transformation through UT. Specifically, the prior learning unit 13 estimates a variance and an average of pseudo data generated by the generation unit 11 using UT before performing GAN learning. The prior learning unit 13 updates a parameter θ of the generation unit 11 to minimize an evaluation function for evaluating a similarity between the estimated variance and average and a variance and an average of true data calculated in advance. In other words, the prior learning unit 13 estimates a variance and an average of data (pseudo data) generated by the generation unit 11, calculates a variance and an average of true data, and updates the parameter θ of the generation unit 11 to minimize a squared norm of these.

In this manner, the learning apparatus 10 uses the variance and the average of data in the prior learning, and it is thus not necessary to set a likelihood function on the assumption of a probabilistic model unlike the method based on a likelihood. Thus, the learning apparatus 10 simply learns the statistic amount of data in advance with a small amount of calculation and can thus enhance efficiency of the learning.

Overview of GAN

In the GAN, probability distribution of data x that is a column vector is optimized as represented by Equation (1) using a random number z that is a column vector that follows probability distribution p_{z}z(z) such as normal distribution.

$$\begin{matrix} [ Math . 1 ] & \\ {min}_{G} {max}_{D} V ( D , G ) = {min}_{G} {max}_{D} {x ∼ {p}_{data} ( x )}_{} [ log D ( x ) ] + {z ∼ {p}_{z} ( z )}_{} [ log ( 1 - D ( G ( z ) ) ) ] & ( 1 )\end{matrix}$$

Here, D and G are called an identifier (identification unit 12) and a generator (generation unit 11), respectively, and are modeled in a neural network. This optimization is achieved through alternative learning of D and G. Although prior learning of D is also conceivable, D and G have to be learned with a satisfactory balance because a gradient becomes zero and learning fails if D becomes a complete identifier.

In GAN learning, the gradient of G becomes substantially zero and learning does not advance if distribution of G(z) and distribution p_{data}(x) are excessively far from each other. As a derivative technique of the GAN, a WGAN based on Wasserstein distance (earth mover distance) has been proposed. In WGAN, θ is learned such that the Wasserstein distance represented by Equation (2) is minimized.

$$\begin{matrix}[ Math . 2 ] & \\ {max}_{w ∈ 𝒲} {x ∼ {p}_{data} ( x )}_{} [ {D}_{w} ( x ) ] + {z ∼ {P}_{z} ( z )}_{} [ {D}_{w} ( {G}_{θ} ( z ) ) ] & ( 2 )\end{matrix}$$

Here, there is a condition that D (referred to as critic rather than the identifier) is K Lipschitz to obtain the Wasserstein distance, and W represents a parameter group that satisfies the condition. In the case of the WGAN, no problem occurs if maximization of D is caused to advance through learning of G. W needs to be a compact group in order for D to be K Lipschitz, and this is realized by restricting a parameter size by an appropriate method in the WGAN. Although there are also other derivative techniques of the GAN such as LSGAN, the embodiment is not limited to these methods, and any model can be applied as long as the model is adapted such that G uses a random number as an input to generate data.

Overview of UT

An average of a certain probability variable z∈Rₙ is assumed to be μ_{z}, and a covariance matrix is assumed to be Σ_{zz}. Also, the column vector x=f(z) is assumed to be an arbitrary nonlinear element f:Rⁿ→R^{p}. At this time, the average μₓ, the variance matrix Σₓₓ, and the covariance matrix Σ_{zx} of x are obtained through appropriate calculation. First, 2n+1 representative points (sigma points) that satisfy Equations (3) and (4) {z(1), 1=0, . . . 2n} are considered.

$$\begin{matrix}[ Math . 3 ] & \\ {\sum }_{l = 0}^{2 n} {W}^{( l )} {z}^{( l )} = {μ}_{z} & ( 3 ) \\ [ Math . 4 ] & \\ {\sum }_{l = 0}^{2 n} {{W}^{( l )} [ {z}^{( l )} - {μ}_{z} ] [ {z}^{( l )} - {μ}_{z} ]}^{T} = {\sum }_{zz} & ( 4 )\end{matrix}$$

Here, W^{(l)} is a weight coefficient that satisfies Equation (5).

$$\begin{matrix}[ Math . 5 ] & \\ {\sum }_{l = 0}^{2 n} {W}^{( l )} = 1 & ( 5 )\end{matrix}$$

Next, nonlinear transform is calculated for the sigma point to obtain x(l)=s(z^{(l)}). A weighted average value at the transformed 2n+1 points is calculated to obtain Equation (6).

$$\begin{matrix}[ Math . 6 ] & \\ {μ}_{x} = {\sum }_{l = 0}^{2 n} {W}^{( l )} {x}^{( l )} & ( 6 )\end{matrix}$$

Finally, a covariance matrix Σ_{zx} is calculated using Equation (7) below.

$$\begin{matrix}[ Math . 7 ] & \\ {\sum }_{xx} = {\sum }_{l = 0}^{2 n} {{W}^{( l )} [ {x}^{( l )} - {μ}_{x} ] [ {x}^{( l )} - {μ}_{x} ]}^{T} & ( 7 )\end{matrix}$$

It is possible to estimate an average and a covariance of probability variables after nonlinear transformation according to the UT. Next, a method for selecting a sigma point necessary for the calculation will be described.

Selection of Sigma Point

First, a square root matrix B∈R^{n×n} of Σ_{zz} is assumed to be Equation (8).

[Math. 8]

Σ_{zz}=BB^{T}, B=[b₁, . . . , bₙ] (8)

At this time, the sigma point and the weight coefficient are assumed to be Equations (9) to (12).

$$\begin{matrix}[ Math . 9 ] & \\ {z}^{( 0 )} = {μ}_{z} , {W}_{m}^{( 0 )} = \frac{λ}{n + λ} , {W}_{c}^{( 0 )} = \frac{λ}{n + λ} + ( 1 - {α}^{2} + β ) & ( 9 ) \\ [ Math . 10 ] & \\ {z}^{( l )} = {μ}_{z} + \sqrt{n + λ} {b}_{l} , {W}^{( l )} = \frac{1}{2 ( n + λ )} , l = 1 , … , n & ( 10 ) \\ [ Math . 11 ] & \\ {z}^{( l )} = {μ}_{z} - \sqrt{n + λ} {b}_{l} , {W}^{( l )} = \frac{1}{2 ( n + λ )} , l = n + 1 , … , 2 n & ( 11 ) \\ [ Math . 12 ] & \\ λ = {α}^{2} ( n + κ ) - η & ( 12 )\end{matrix}$$

Here, W⁽⁰⁾ₘ and W⁽⁰⁾_{c} are weights for obtaining an average and a covariance, respectively, and κ, β, and α are hyperparameters, the setting of which has policies as will be described later.

### Method of Embodiment

Hereinafter, a method of the specification according to the embodiment will be described. Although an example of a method for realizing the learning method according to the embodiment in which an input to the generation unit 11 is assumed to be normal distribution of an average 0 and a variance I and a squared norm is used as an evaluation criterion of the variance and the average will be described, the method for realizing the learning method is not limited thereto.

Prior Learning of GAN Using UT

In the GAN, the probability variable z before an application to the model is obtained from normal distribution of the average 0 and the variance I in many cases. At this time, the sigma point is obtained from Equations (13) to (15).

[Math. 13]

z⁽⁰⁾=0 (13)

[Math. 14]

z^{(l)}=\sqrt{n+λ}uₗ, l=1, . . . , n (14)

[Math. 15]

z^{(l)}=−\sqrt{n+λ}uₗ, l=+1, . . . , 2n (15)

However, uₗ is an orthogonal vector, and for example, a singular vector or the like obtained by performing singular value decomposition (SVD) on an appropriate matrix is used. In a case in which distribution of z applied to the nonlinear function is a normal distribution when the UT is used, β=2 is assumed to be optimal. Because the value of κ is not important, the value may typically be defined as =0. Finally, α may be selected from 0≤α≤1. For α, although it is considered that a smaller value may be selected as the nonlinearity of the nonlinear function increases, there is also a result that a large value is better in the case of a high order.

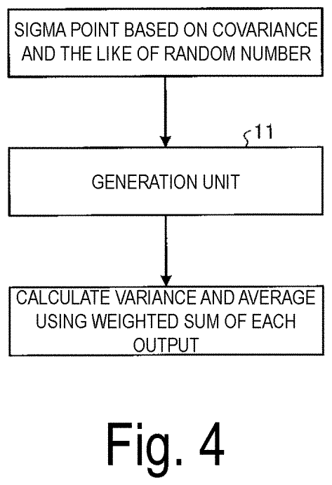

FIG. 4 is a diagram for explaining an application of the UT to the generation unit 11 illustrated in FIG. 1. As illustrated in FIG. 4, it is possible to obtain an approximate value of the average value and the variance of \hat{ }x=G(z) obtained by the generation unit 11 in the GAN by performing the UT as described above.

At this time, the shape of the distribution of \hat{ }x is not assumed. In a case in which the generation unit 11 serves as a data generation model, the statistic amount (such as an average and a variance) of outputs of the generation unit 11 conforms to the statistic amount of data. Thus, the generation unit 11 calculates an average value of μ_{xdata} and a variance Σ_{xdata} of x from the data in response to control performed by the prior learning unit 13 and performs prior learning such that the calculated average value and the variance conform to an estimated average μ_{\hat{ }x} and a variance Σ_{\hat{ }x} of the generation unit 11.

Specifically, an evaluation function for evaluating similarity thereof is prepared, and the parameter θ of the generation unit 11 is updated to minimize the evaluation function. The evaluation function is set, for example, using a squared norm as represented by Equation (16).

$$\begin{matrix}[ Math . 16 ] & \\ {min}_{θ} {‖ {μ}_{{x}_{data}} - {μ}_{\hat{x}} ‖}^{2} + {‖ {\sum }_{{x}_{data}} - {\sum }_{\hat{x}} ‖}_{F}^{2} & ( 16 )\end{matrix}$$

The prior learning unit 13 ends the prior learning performed by the generation unit 11 on the basis of the fact that the value of the evaluation function is small, the fact that the learning has been performed for a specific period of time, or the like. Then, the generation unit 11 and the identification unit 12 perform learning of the original GAN using the parameter of the generation unit 11 obtained through the prior learning as an initial value.

The prior learning is a simpler task than learning of actual data generation distribution, and also, the learning can be achieved with 2n sigma points, which is fewer than the number of data items. Further, because the identification unit 12 is not used in the prior learning, the learning can be achieved with a significantly smaller amount of calculation than that for the learning of the GAN. It is assumed that the number of data items is N, for example, calculation orders of an average value μ_{xdata} and a variance Σ_{xdata} of the data are O(Np) and O(Np²). As compared with the amount of calculation for back error propagation per one epoch of perceptron of one n unit layer being O(Nn²), for example, for example, the calculation orders of the average value μ_{xdata} and a variance Σ_{xdata} of the data are smaller. Also, because the generation unit 11 generates a sample that is closer to true generation distribution through prior learning, and there are effects such as ease of obtaining a gradient, it is possible to shorten the learning time.

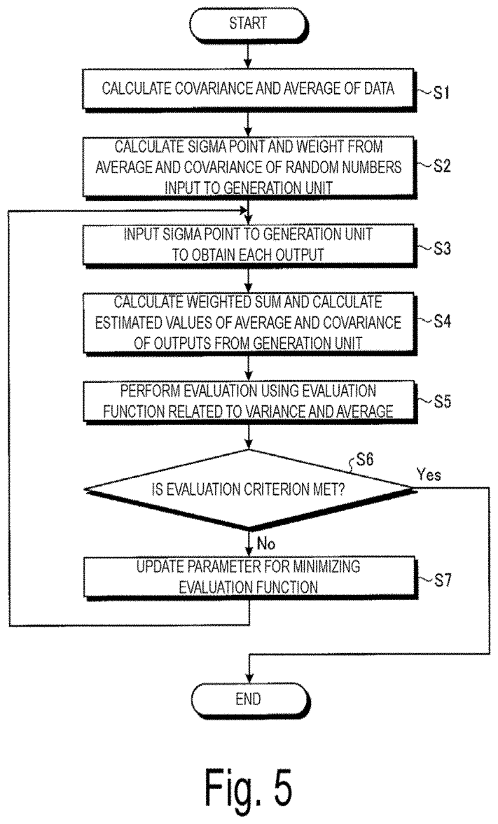

Prior learning processing Next, a processing procedure for prior learning processing performed by the learning apparatus 10 will be described. FIG. 5 is a flowchart illustrating a processing procedure for the prior learning processing according to the embodiment.

As illustrated in FIG. 5, the prior learning unit 13 calculates a covariance and an average of data (Step S1). Next, the prior learning unit 13 calculates a sigma point and a weight from an average and a covariance of random numbers input to the generation unit 11 (Step S2). The prior learning unit 13 inputs the sigma point to the generation unit 11 and obtains each output (Step S3). Then, the prior learning unit 13 calculates a weighted sum and calculates estimated values of an average and a covariance of the outputs from the generation unit 11 (Step S4).

Next, the prior learning unit 13 performs evaluation using an evaluation function related to the average and the variance (Step S5). For example, the prior learning unit 13 uses a squared norm of estimated values of an average and a variance of pseudo data generated by the generation unit 11 and an average and a variance of true data as an evaluation function, and evaluates a similarity between the estimated variance and average and the variance and the average of true data calculated in advance.

Then, the prior learning unit 13 determines whether or not the evaluation result satisfies an evaluation criterion (step S6). For example, the prior learning unit 13 determines whether or not the squared norm is equal to or less than a predetermined reference value.

In accordance with a determination of the prior learning unit 13 that the evaluation result does not satisfy the evaluation criterion (Step S6: No), the prior learning unit 13 updates of the parameter of the generation unit 11 to minimize the evaluation function (Step S7), and executes processing in and after Step S3. On the other hand, in accordance with a determination of the prior learning unit 13 that the evaluation result satisfies the evaluation criterion (Step S6: Yes), the prior learning unit 13 ends the prior learning processing.

### Effects of Embodiment

As described above, the learning apparatus 10 according to the embodiment causes the generation unit having the mathematical model for generating data through an input of a random number used for deep learning to a nonlinear function to execute prior learning of a variance and an average using UT. Specifically, according to the embodiment, a variance and an average of data generated by the generation unit are estimated using the UT, and the parameter of the generation unit 11 is updated to minimize the evaluation function for evaluating a similarity between the estimated variance and average and a variance and an average of true data calculated in advance, in the prior learning.

In this manner, because the variance and the average of data are used in the prior learning, it is not necessary to set a likelihood function on the assumption of a probabilistic model unlike the method based on a likelihood in the embodiment. It is thus possible to enhance efficiency of learning through simple prior learning of the statistic amount of data with a small amount of calculation according to the embodiment.

Concerning System Configuration of Embodiment

Each component of the learning apparatus 10 illustrated in FIG. 1 is a functional concept and may not necessarily be physically configured as in the drawing. In other words, a specific form of distribution and merging of the functions of the learning apparatus 10 is not limited to that which is illustrated, and all or some can be configured in a functionally or physically distributed or merged manner in arbitrary units, in accordance with various loads, use conditions, and the like.

All or an arbitrary number of processes performed by the learning apparatus 10 may be realized by a CPU and a program that is analyzed and executed by the CPU. Moreover, each of the processes performed by the learning apparatus 10 may be realized as hardware based on a wired logic.

All or some of processes described as automatically performed processes, among the processes described in the embodiment, can also be performed manually. Alternatively, all or some of processes described as manually performed processes can also be performed automatically by known methods. In addition, the aforementioned and illustrated processing procedures, control procedures, specific names, and information including various kinds of data and parameters can appropriately be changed unless particularly stated otherwise.

Program

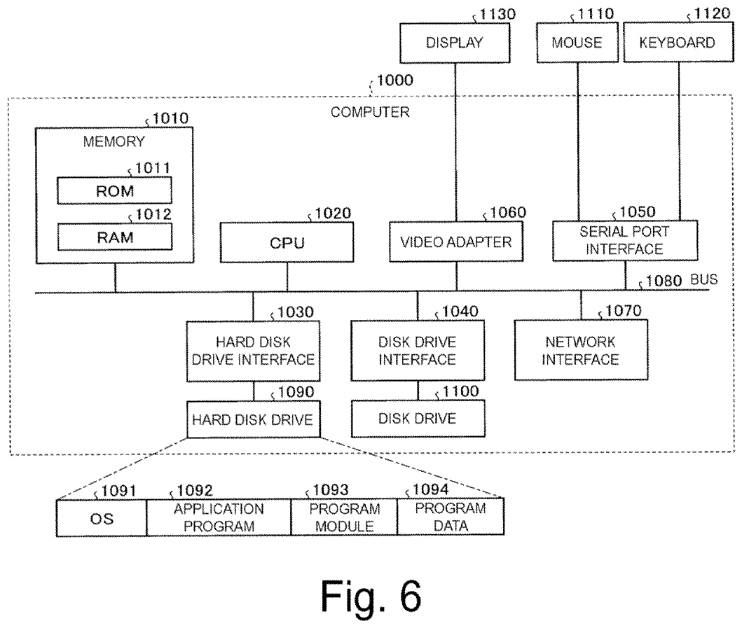

FIG. 6 is a diagram illustrating an example of a computer that realizes the learning apparatus 10 by executing a program. A computer 1000 includes, for example, a memory 1010 and a CPU 1020. The computer 1000 includes a hard disk drive interface 1030, a disk drive interface 1040, a serial port interface 1050, a video adapter 1060, and a network interface 1070. These units are connected by a bus 1080.

The memory 1010 includes a ROM 1011 and a RAM 1012. The ROM 1011 stores a boot program, such as Basic Input Output System (BIOS), for example. The hard disk drive interface 1030 is connected to a hard disk drive 1090. The disk drive interface 1040 is connected to a disk drive 1100. A detachable storage medium such as a magnetic disk or an optical disc is inserted into the disk drive 1100. The serial port interface 1050 is connected, for example, to a mouse 1110 and a keyboard 1120. The video adapter 1060 is connected, for example, to a display 1130.

The hard disk drive 1090 stores, for example, an Operating System (OS) 1091, an application program 1092, a program module 1093, and program data 1094. In other words, a program defining each process of the learning apparatus 10 is implemented as the program module 1093 in which a code executable by the computer 1000 is described. The program module 1093 is stored in, for example, the hard disk drive 1090. For example, the program module 1093 for executing the same process as that of a functional configuration in the learning apparatus 10 is stored in the hard disk drive 1090. Note that the hard disk drive 1090 may be replaced with a Solid State Drive (SSD).

Setting data used in the aforementioned processing according to the embodiment is stored as program data 1094 in the memory 1010 or the hard disk drive 1090, for example. In addition, the CPU 1020 reads and executes the program module 1093 and the program data 1094 stored in the memory 1010 and the hard disk drive 1090 to the RAM 1012 as necessary.

Note that the program module 1093 and the program data 1094 are not limited to being stored in the hard disk drive 1090, and may be stored, for example, in a removable storage medium, and read by the CPU 1020 via the disk drive 1100 or its equivalent. Alternatively, the program module 1093 and the program data 1094 may be stored in another computer connected via a network (such as a LAN or a wide area network (WAN)). In addition, the program module 1093 and the program data 1094 may be read by the CPU 1020 from another computer through the network interface 1070.

Although embodiments to which the present invention made by the inventor is applied have been described above, the present invention is not limited by the description and the drawings that form a part of the disclosure of the present invention according to the present embodiments. In other words, other embodiments, examples, operation techniques, and the like implemented by those skilled in the art on the basis of the present embodiment are all included in the scope of the present invention.

### REFERENCE SIGNS LIST

10 Learning apparatus
11 Generation unit
12 Identification unit
13 Prior learning unit
14, 15 Deep learning model

1. A learning apparatus comprising:
generation circuitry having a mathematical model for generating data through an input of a random number used for deep learning to a nonlinear function; and
prior learning circuitry configured to cause the generation circuitry to execute prior learning of a variance and an average using unscented transform.

2. The learning apparatus according to claim 1, wherein the prior learning circuitry estimates the variance and the average of the data generated by the generation circuitry using the unscented transform and updates a parameter of the generation circuitry to minimize an evaluation function for evaluating a similarity between the estimated variance and average and a variance and an average of true data calculated in advance.

3. The learning apparatus according to claim 2, wherein the prior learning circuitry updates the parameter of the generation circuitry to minimize a squared norm of the estimated variance and average and the variance and the average of the true data calculated in advance.

4. A learning method executed by a learning apparatus, the learning apparatus including generation circuitry having a mathematical model for generating data through an input of a random number used for deep learning to a nonlinear function, the method comprising:
at the generation circuitry, executing prior learning of a variance and an average using unscented transform.

5. A non-transitory computer readable medium including computer instructions for causing a computer to function as the learning apparatus according to claim 1.

6. A non-transitory computer readable medium including computer instructions for causing a computer to execute the method of claim 4.
